(19) United States
(12) Patent Application Publication
(10) Pub. No.: US 2020/0327548 A1
(43) Pub. Date: Oct. 15, 2020

(54) MERCHANT CLASSIFICATION BASED ON CONTENT DERIVED FROM WEB CRAWLING MERCHANT WEBSITES

(71) Applicant: Square, Inc., San Francisco, CA (US)

(72) Inventor: Benjamin Hartard, San Francisco, CA (US)

(21) Appl. No.: 15/599,928

(22) Filed: May 19, 2017

(51) Int. Cl. G06Q 20/40; G06F 17/30; G06Q 20/12; G06Q 30/02

(52) U.S. Cl. CPC G06Q 20/4016; G06F 17/30864; G06Q 30/0225; G06Q 20/127; G06Q 20/12

(57) ABSTRACT

Techniques for classifying a merchant based on content derived from crawling a website associated with the merchant are described. As an example, a payment processing service may receive an indication to crawl a website associated with a merchant. The website may be accessible by a Uniform Resource Locator (URL). The payment processing service may access the website via the URL and may analyze, via a web crawler, a structure of the website to derive content of the website. Based at least in part on a previously trained data model and the content of the website, the payment processing service may determine a classification of the merchant. The classification may identify the merchant as a fraudulent merchant or may identify the merchant as a candidate for a particular service offered by the payment processing service.

### BACKGROUND

Merchants offer items (i.e., goods, services, etc.) for acquisition (i.e., sale, rent, lease, etc.) by customers. Merchants often utilize websites to promote their businesses. Websites may provide information about merchants, such as physical locations of merchants, contact information for merchants, etc. Websites may additionally and/or alternatively include access to various tools to enable consumers to interact with the websites. For instance, a website may have an e-commerce tool that enables consumers to shop for items offered by a merchant for acquisition. Or, a website may have a reservation tool that enables consumers to make reservations for services (e.g., spa, restaurant, etc.) provided by a merchant at a physical location of the merchant.

### BRIEF DESCRIPTION OF THE DRAWINGS

The above and other features of the present disclosure, its nature and various advantages, will be more apparent upon consideration of the following detailed description, taken in conjunction with the accompanying drawings in which:

FIG. 1 depicts a non-limiting flow diagram illustrating a method for classifying a merchant based on content derived from web crawling a website of the merchant;

FIG. 2 depicts an illustrative block diagram of a system associated with classifying merchant(s) based on content derived from web crawling website(s) of the merchant(s) in accordance with some examples of the present disclosure;

FIG. 3 depicts a non-limiting flow diagram illustrating a method for training a data model to determine a complexity score associated with a website in accordance with some examples of the present disclosure;

FIG. 4 depicts a non-limiting flow diagram illustrating a method for training a data model to determine a classification of a merchant in accordance with some examples of the present disclosure;

FIG. 5 depicts a non-limiting flow diagram illustrating a method for classifying a merchant based at least in part on content associated with a web site of the merchant in accordance with some examples of the present disclosure;

FIG. 6 depicts a non-limiting flow diagram illustrating a method for classifying a merchant as a fraudulent merchant based at least in part on a complexity score in accordance with some examples of the present disclosure; and

FIG. 7 depicts a non-limiting flow diagram illustrating a method for classifying a merchant as a target merchant based at least in part on a complexity score in accordance with some examples of the present disclosure.

In the figures, the left-most digit(s) of a reference number identifies the figure in which the reference number first appears. The use of the same reference numbers in different figures indicates similar or identical items or features. Moreover, multiple instances of the same part are designated by a common prefix separated from the instance number by a dash. The drawings are not to scale.

### DETAILED DESCRIPTION

A payment processing service may offer a variety of services to help merchants streamline their businesses. In at least one example, a payment processing service may offer point-of-sale (POS) systems which are associated with various applications associated with the payment processing service that ease POS interactions with customers. A POS system may include a POS terminal and a payment reader. The payment reader may physically interact with payment instruments such as magnetic stripe payment cards, EMV payment cards, and short-range communication (e.g., near field communication (NFC), radio frequency identification (RFID), Bluetooth®, Bluetooth® low energy (BLE), etc.) payment instruments. The POS terminal may provide a rich user interface, communicate with the payment reader, and also communicate with a server associated with the payment processing service. In this manner, the POS terminal and payment reader may collectively process transaction(s) between a merchant and customer(s).

In some examples, the payment processing service may additionally and/or alternatively provide services to enable merchants to manage other aspects of their businesses. As examples, the payment processing service may provide services for processing payments (i.e., a payment processing service), managing content (i.e., a content management service), managing customer relationships (i.e., a customer relationship management service), providing an e-commerce platform (i.e., an e-commerce platform service), providing an e-commerce cart (i.e., an e-commerce cart service), managing marketing (i.e., a marketing service), scheduling appointments (i.e., a scheduling service), managing reservations (i.e., a reservation service), enabling online food service (i.e., a food ordering service), hosting websites (i.e., a website hosting service), managing gift cards (i.e., a gift card management service), managing loyalty programs (i.e., a loyalty program service), etc.

In at least one example, techniques described herein may be useful for engaging new merchants. For instance, techniques described herein are directed to identifying merchants that do not subscribe to services offered by a payment processing service and may benefit from one or more services available from the payment processing service. Such merchants may be target merchants, i.e., merchants to which the payment processing service may target their services. Based at least in part on identifying said merchants, techniques described herein are directed to marketing to said merchants to offer them access to one or more services from which they may benefit. That is, in at least one example, techniques described herein may be useful for determining which merchants to target for marketing services offered by the payment processing service. In additional and/or alternative examples, techniques described herein may be useful for upselling to existing merchants. For instance, techniques described herein are directed to identifying merchants that subscribe to services offered by a payment processing service and may benefit from one or more services available from the payment processing service that the merchants are not currently using. Based at least in part on identifying said merchants, techniques described herein are directed to marketing to said merchants to offer them access to one or more services from which they may benefit.

Furthermore, techniques described herein may be useful for identifying fraudulent merchants. Fraudulent merchants front as merchants but have an intention to deceive customers. Fraudulent merchants may attempt to (and often successfully do) steal personal information from customers, credit card information from customers, funds from customers, etc. Techniques described herein are directed to identifying fraudulent merchants and, based at least in part on identifying said fraudulent merchants, preventing or terminating access to the payment processing service for said fraudulent merchants.

In at least one example, techniques described herein are directed to a web crawler that is configured to access websites via network locations (e.g., Uniform Resource Locators (URLs), etc.) associated with the websites and to analyze the websites to determine complexities of the websites. For the purpose of this discussion, a web crawler may be software that visits one or more web sites respectively corresponding to one or more URLs. In some examples, the web crawler may download data associated with the one or more websites for subsequent access and analysis. In at least one example, the web crawler may recursively visit the one or more websites based on a set of policies. The set of policies may indicate which website(s) and/or data associated with the website(s) to download, when to revisit website(s), how to avoid overloading website(s), how to coordinate distributed web crawlers, etc.

In at least one example, the web crawler may analyze a structure of a website to derive content of the website. Based at least in part on the structure of the website, techniques described herein may determine one or more applications associated with the website, application providers associated with the one or more applications, metrics associated with functionality(s) of the website, contact(s) of the corresponding merchant that are identifiable via the website, contact data (e.g., telephone number(s), email address(es), physical address(es), etc.) associated with the corresponding merchant that is identifiable via the website, etc. For the purpose of this discussion, an application may be software designed to perform a task (or one or more coordinated tasks) on behalf of a merchant. Applications may be used by a merchant for processing payments (i.e., a payment processing application), managing content (i.e., a content management application), managing customer relationships (i.e., a customer relationship management application), providing an e-commerce platform (i.e., an e-commerce platform application), providing an e-commerce cart (i.e., an e-commerce cart application), managing marketing (i.e., a marketing application), scheduling appointments (i.e., a scheduling application), managing reservations (i.e., a reservation application), enabling online food service (i.e., a food ordering application), hosting websites (i.e., a website hosting application), managing gift cards (i.e., a gift card management application), managing loyalty programs (i.e., a loyalty program application), etc. An application provider associated with an application may be a service provider, content provider, etc. that offers the application. For instance, SHOPIFY® is an example of an application provider of an ecommerce platform application, MAILCHIMP® is an example of an application provider of a marketing application, GRUBHUB® is an example of an application provider for a food ordering application, etc. In some examples, the payment processing service described herein may be an application provider of one or more applications.

Techniques described herein may determine a score indicative of the complexity of the website (i.e., a complexity score) based on the aforementioned website content. For instance, techniques described herein may determine that a website that includes a payment processing application, a food ordering application, and a reservation application is a high-level (i.e., sophisticated) website and accordingly, may assign a complexity score above a threshold complexity score, or within a particular range of complexity scores, to the website. Or, techniques described herein may determine that a website that includes a payment processing application, and only a payment processing application, is a low-level (i.e., unsophisticated) website and accordingly, may assign a complexity score below a threshold complexity score, or outside of a particular range of complexity scores, to the website. Further, in some examples, a URL, or other network locator, may provide access to an invalid web site. In such examples, techniques described herein may assign a complexity score below a threshold complexity score, or outside of a particular range of complexity scores, to the website. In at least one example, combinations of applications, application provider(s) associated with application(s), contact(s), contact data, etc. may increase or decrease a complexity score determined for a website.

In some examples, techniques described herein may classify the merchant based at least in part on the complexity score. In additional and/or alternate examples, techniques described herein may classify a merchant based on content derived from the website structure (i.e., without using the complexity score). As non-limiting examples, techniques described herein may classify a merchant as a merchant that may benefit from a particular service (e.g., a reservation service, a content management service, etc.), a fraudulent merchant, a target merchant, etc.

While techniques described herein are directed to classifying merchants based on content derived from a structure of a website, such techniques are not limited to such an example. For instance, in additional and/or alternative examples, techniques described herein may be used to classify merchants based on content derived from other computing resources such as, but not limited to, application(s), intranet site(s), private site(s), etc. In such examples, network locator(s) (e.g., URL(s), etc.) or other resource identifier(s) may be used to access the computing resource(s).

The following description provides specific details for a thorough understanding and an enabling description of these implementations. One skilled in the art will understand, however, that the disclosed system and methods may be practiced without many of these details. Additionally, some well-known structures or functions may not be shown or described in detail, so as to avoid unnecessarily obscuring the relevant description of the various implementations. The terminology used in the description presented below is intended to be interpreted in its broadest reasonable manner, even though it is being used in conjunction with a detailed description of certain specific implementations of the disclosed system and methods. Some frequently used terms are now described.

The phrases “in some examples,” “according to various examples,” “in the examples shown,” “in one example,” “in other examples,” “various examples,” “some examples,” and the like generally mean the particular feature, structure, or characteristic following the phrase is included in at least one example of the present invention, and may be included in more than one example of the present invention. In addition, such phrases do not necessarily refer to the same examples or to different examples.

If the specification states a component or feature “can,” “may,” “could,” or “might” be included or have a characteristic, that particular component or feature is not required to be included or have the characteristic.

The term “module” refers broadly to software stored on non-transitory storage medium (e.g., volatile or non-volatile memory for a computing device), hardware, or firmware (or any combination thereof) modules. Modules are typically functional such that they that may generate useful data or other output using specified input(s). A module may or may not be self-contained. An application program (also called an “application”) may include one or more modules, or a module may include one or more application programs.

The preceding introduction is provided for the purposes of summarizing some examples to provide a basic understanding of aspects of the subject matter described herein. Accordingly, the above-described features are merely examples and should not be construed as limiting in any way. Other features, aspects, and advantages of the subject matter described herein will become apparent from the following description of Figures and Claims.

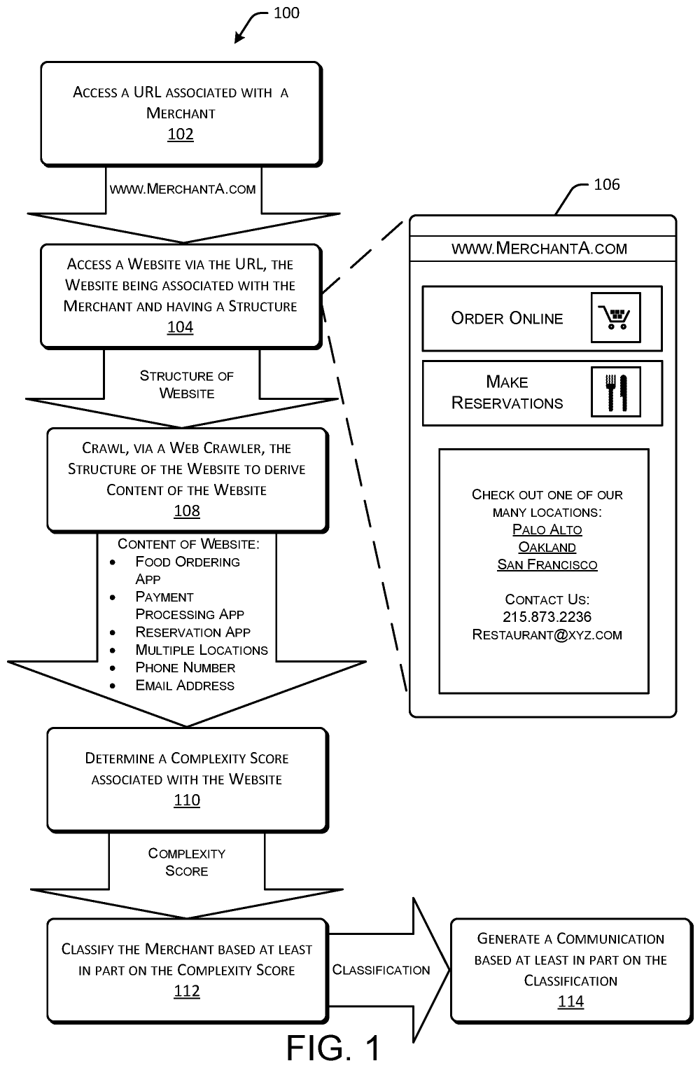

FIG. 1 depicts an illustrative flow diagram illustrating a method 100 for classifying a merchant based on content derived from web crawling a website of the merchant.

Block 102 illustrates accessing a URL associated with a merchant. In at least one example, techniques described herein may access a URL (or other network locator) associated with a merchant. In some examples, the URL may be submitted by a merchant in association with a request to open a new account with a payment processing service. In other examples, the URL may be associated with a plurality of URLs of merchants that have existing accounts with the payment processing service or merchants that do not have existing accounts with the payment processing service, but may benefit from services offered by the payment processing service.

Block 104 illustrates accessing a website via the URL, the website being associated with the merchant and having a structure. In at least one example, techniques described herein may access a website via actuation of an access mechanism associated with the URL. A non-limiting example of a graphical user interface 106 associated with a website is depicted in FIG. 1. The website that is accessible via the URL may be associated with the merchant (e.g., Merchant A) and may have a structure, which may describe content of the web site. The structure may be described in a programming language for creating webpages, web applications, websites, etc. (e.g., Hypertext Markup Language (HTML), Javascript, Cascading Style Sheets (CSS), etc.).

Block 108 illustrates crawling, via a web crawler, the structure of the website to derive content of the web site. In at least one example, a web crawler may visit the web site based on a set of policies and may analyze the structure of the website. In some examples, the web crawler may download data associated with the website for subsequent access and analysis. As a non-limiting example, a structure associated with the web site corresponding to graphical user interface 106 may describe that the website is associated with a food ordering application, a payment processing application, and a reservation application. Additionally, the structure may describe that the website is associated with data identifying multiple merchant locations (e.g., Palo Alto, Oakland, San Francisco, etc.), a telephone number, and an email address.

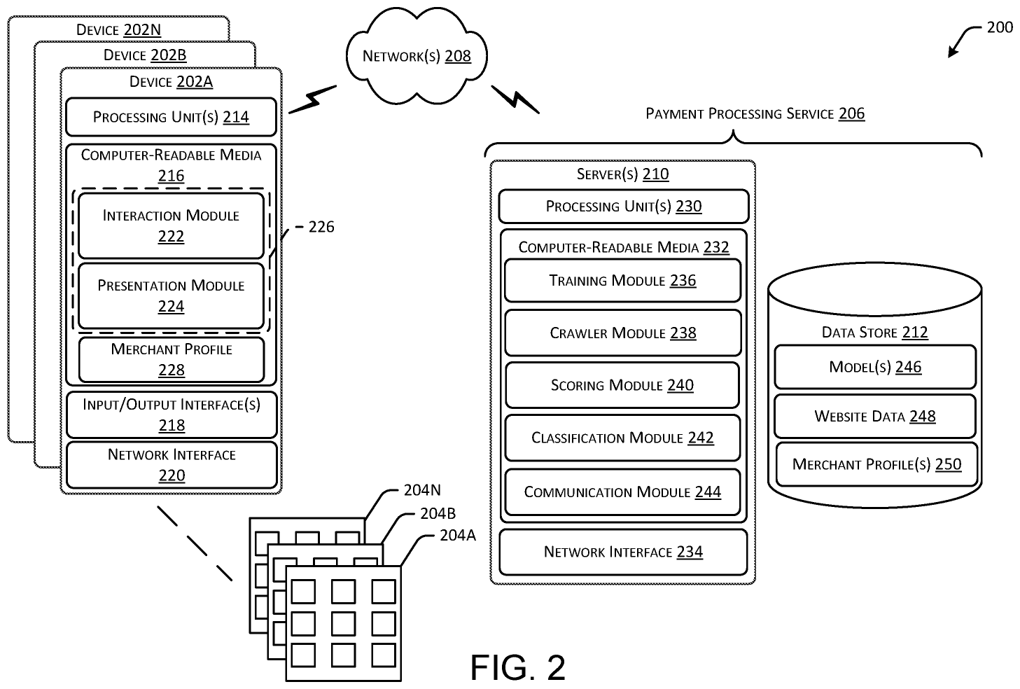

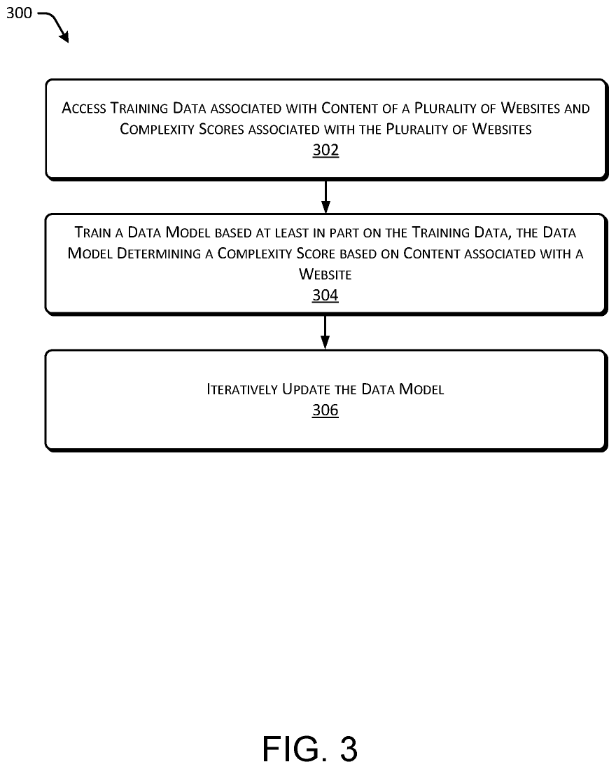

Block 110 illustrates determining a complexity score associated with the website. In at least one example, techniques described herein may leverage the content of the website to determine a complexity score associated with the website. In at least one example, a set of rules may be used to determine a complexity score. In additional and/or alternative examples, a data model may be used to determine a complexity score. The data model may be trained using a machine learning mechanism, which is described below with reference to FIGS. 2 and 3.

In at least one example, the complexity score may be based on one or more applications determined to be associated with the web site, application providers associated with the one or more applications, metrics associated with functionality(s) of the website, contact(s) of the corresponding merchant that are identifiable via the website, contact data (e.g., telephone number(s), email address(es), physical address(es), etc.) associated with the corresponding merchant that is identifiable via the website, etc. Combinations of applications may affect the complexity score. The presence or absence of certain application providers may affect the complexity score. The number of contact(s) of a merchant may affect the complexity score. The number of merchant locations of a merchant may affect the complexity score. The presence or absence of contact information and/or the type of contact information that is present may affect the complexity score. Additional details associated with determining a complexity score are described below.

In at least one example, a complexity score above a threshold complexity score, or within a particular range of complexity scores, may indicate that a website is a high-level (i.e., sophisticated) website and a complexity score below a threshold complexity score, or outside of the particular range of complexity scores, may indicate that a website is a low-level (i.e., unsophisticated) website. In some examples, different ranges of complexity scores may represent different levels of complexity.

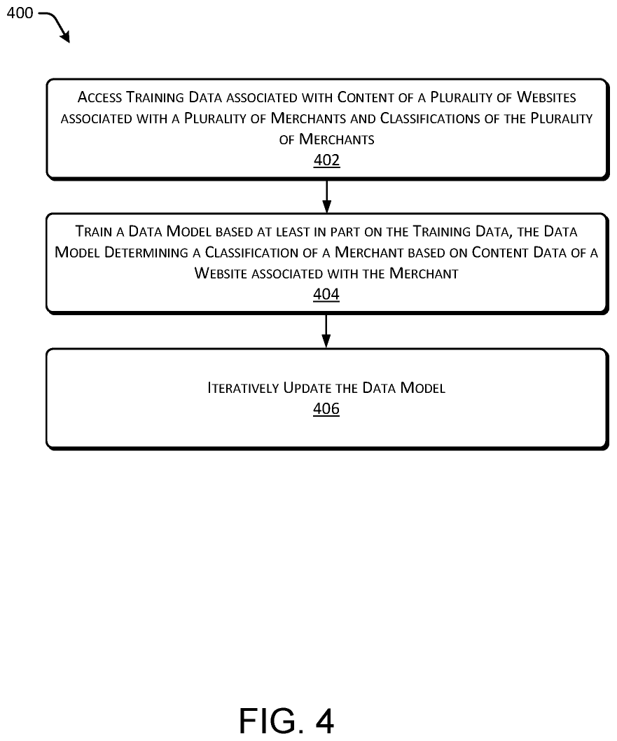

Block 112 illustrates classifying the merchant based at least in part on the complexity score. In at least one example, techniques described herein may classify a merchant based at least in part on the complexity score. In additional and/or alternative examples, techniques described herein may leverage a data model to classify a merchant based at least in part on the complexity score. That is, the complexity score may be an input to the data model. The data model may be trained using a machine learning mechanism, which is described below with reference to FIGS. 2 and 4.

In at least one example, techniques described herein may classify the merchant as a fraudulent merchant based at least in part on the complexity score. Or, in another example, techniques described herein may classify the merchant as a target merchant based at least in part on the complexity score. In an additional and/or alternate example, the techniques described herein may classify the merchant as a merchant that may benefit from a particular service offered by the payment processing service based at least in part on the complexity score.

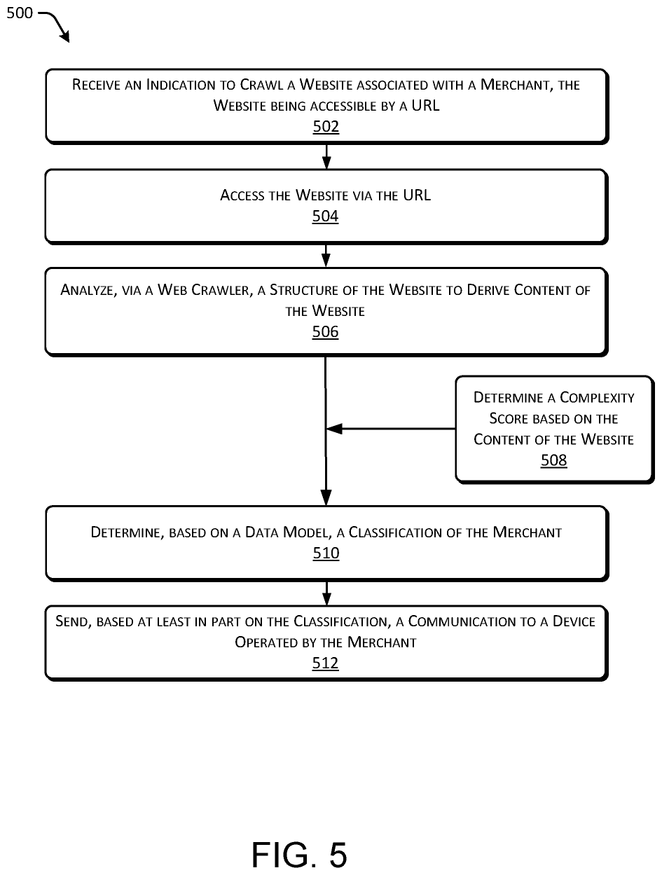

As described herein, in alternate examples, techniques described may classify the merchant based on the content of the web site without determining a complexity score. Additional details associated with classifying a merchant are described below with reference to FIGS. 5-7.

Block 114 illustrates generating a communication based at least in part on the classification. In at least one example, techniques described herein may generate a communication based at least in part on the classification. A communication may be an email, a text message, a SMS or MMS message, a push notification, content presented via a webpage, etc. that may be sent to a device operated by the merchant. In some examples—for instance, when the classification indicates that the merchant is a fraudulent merchant—the communication may be an indication denying or terminating access to the payment processing service. In other examples—for instance, when the classification indicates that the merchant is a target merchant and/or may benefit from a particular service offered by the payment processing service—the communication may be an advertisement or some other promotional communication promoting the service and/or the payment processing service.

FIG. 2 depicts an illustrative block diagram of a system 200 associated with classifying merchant(s) based on content derived from web crawling website(s) of the merchant(s). The system 200 may include device(s) 202A-202N (collectively, devices 202) respectively operated by merchant(s) 204A-204N (collectively, merchants 204), which are communicatively coupled to a payment processing service 206 via network(s) 208.

Details of device 202A are described herein; however, each of the devices 202 may be configured in a substantially same configuration. Device 202A may be any type of computing device such as a tablet computing device, a smart phone or mobile communication device, a laptop, a netbook or other portable computer or semi-portable computer, a desktop computing device, a terminal computing device or other semi-stationary or stationary computing device, a dedicated register device, a wearable computing device or other body-mounted computing device, an augmented reality device, etc. In at least one example, device 202A may be a point-of-sale (POS) terminal, which may be connected to a payment reader device. That is, in at least one example, device 202A may be associated with a POS system. In such an example, the payment reader device may be capable of accepting a variety of payment instruments, such as credit cards, debit cards, gift cards, short-range communication based payment instruments, and the like. In one example, a payment reader device may be a wireless communication device that communicates wirelessly with an interactive electronic device such as device 202A, for example, using Bluetooth®, BLE, NFC, RFID, etc. In another example, a payment reader device may be coupled to an interactive electronic device such as a device 202A, for example, by being insertable into a connector mechanism (e.g., phone jack, headphone jack, etc.) of a smart phone or tablet. That is, in other examples, the payment reader device may be coupled to the device 202A via a wired connection. The payment reader device may interact with a payment instrument via a tap, dip, or swipe to obtain payment data associated with a customer.

Merchant 204A may operate device 202A. As described above, a merchant, e.g., merchant 204A, may be any individual, company, service provider, etc. that offers items for acquisition by customer(s). An item may be a good or a service. A customer may acquire an item by purchasing the item, renting the item, leasing the item, etc. In at least one example, a merchant, e.g., merchant 204A, may be a fraudster (e.g., fraudulent merchant), as described above. In an additional and/or alternative example, a merchant, e.g., merchant 204A, may be a target merchant. In some examples, a merchant 204A (i.e., an agent of the merchant 204A) that subscribes to services available by the payment processing service 206 may interact with the device 202A to process transactions and/or manage other aspects of the merchant's business via services available by the payment processing service 206. The payment processing service 206 may include one or more servers 210 and a data store 212, described below.

Device 202A may include processing unit(s) 214, computer-readable media 216, input/output interface(s) 218, and a network interface 220. The processing unit(s) 214 of the device 202A may execute one or more modules and/or processes to cause the device 202A to perform a variety of functions, as set forth above and explained in further detail in the following disclosure. In some examples, the processing unit(s) 214 may include a central processing unit (CPU), a graphics processing unit (GPU), both CPU and GPU, or other processing units or components known in the art. Additionally, each of the processing unit(s) 214 may possess its own local memory, which also may store program modules, program data, and/or one or more operating systems. Depending on the exact configuration and type of the device 202, the computer-readable media 216 may include volatile memory (such as RAM), non-volatile memory (such as ROM, flash memory, miniature hard drive, memory card, or the like), or some combination thereof. In various examples, the device 202A may include input/output interface(s) 218. Examples of input/output interface(s) 218 may include a keyboard, a mouse, a pen, a voice input device, a touch input device, a display, etc. Furthermore, the device 202A may include a network interface 220 for interfacing with the network(s) 208, as described below.

In at least one example, the computer-readable media 216 may include one or more modules to enable a merchant, e.g., merchant 204A, to manage its business via interactions with the payment processing service 206. The one or more modules may be implemented as more modules or as fewer modules, and functions described for the modules may be redistributed depending on the details of the implementation. As described above, the term “module” refers broadly to software stored on non-transitory storage medium (e.g., volatile or non-volatile memory for a computing device), hardware, or firmware (or any combination thereof) modules. Modules are typically functional such that they that may generate useful data or other output using specified input(s). A module may or may not be self-contained. An application program (also called an “application”) may include one or more modules, or a module may include one or more application programs. In some examples, a module may include an Application Program Interface (API) to perform some or all of its functionality (e.g., operations). In additional and/or alternative examples, the module(s) may be implemented as computer-readable instructions, various data structures, and so forth via at least one processing unit (e.g., processing unit(s) 214) to configure the device 202A to execute instructions and to perform operations described herein. The module(s) may include an interaction module 222 and a presentation module 224. In some examples, the interaction module 222 and the presentation module 224 may be associated with a merchant point-of-sale application 226. In at least one example, the computer-readable media 216 may also include a merchant profile 228.

The interaction module 222 may enable the device 202A to communicate with the payment processing service 206. In at least one example, the interaction module 222 may receive merchant data input by the merchant 204A. Merchant data may include information about the merchant 204A (e.g., name of the merchant, geographic location of the merchant, types of goods or services offered by the merchant, operating hours of the merchant, a merchant identifier, a merchant category classification, a URL associated with the merchant website, etc.), information about events associated with the merchant 204A (e.g., past and upcoming events, dates of events, locations of events, etc.), accounting information associated with the merchant 204A (e.g., bank(s) that the merchant banks with, etc.), etc. Furthermore, the interaction module 222 may receive a URL, or some other network locator, associated with the merchant 204A. The URL may identify a location of a website associated with the merchant 204A on the Internet or another computer network. Actuation of an access mechanism associated with the URL may enable access to the website. In some examples, the interaction module 222 may receive merchant data (including the URL) in association with a request to set up an account with the payment processing service 206. In additional and/or alternative examples, the interaction module 222 may receive merchant data (including the URL) at a time after the merchant 204A sets up an account with the payment processing service 206.

The interaction module 222 may exchange communication(s) with the payment processing service 206. For instance, the interaction module 222 may send the merchant data (including the URL) to the payment processing service 206. Moreover, the interaction module 222 may send request(s) to open a new account on behalf of the merchant 202A and/or to access a new Application Program Interface (API) associated with the payment processing service 206. Additionally and/or alternatively, the interaction module 222 may receive communication(s) from the payment processing service 206. For instance, in some examples, the interaction module 222 may receive a communication indicating that access to the payment processing service 206 is denied or terminated. Or, in other examples, the interaction module 222 may receive a communication promoting a service offered by the payment processing service 206.

The presentation module 224 may generate and/or present graphical user interfaces. In at least one example, the presentation module 224 may generate and/or present a graphical user interface configured to enable the merchant 204A to input merchant data. In at least one example, such a graphical user interface may include a prompt to input a URL associated with the merchant 204A. In additional and/or alternative examples, the presentation module 224 may generate and/or present a graphical user interface associated with a communication received from the payment processing service 206. For instance, the presentation module 224 may access a communication indicating that access to the payment processing service 206 is denied and may generate a graphical element to present via a graphical user interface to indicate that access to the payment processing service 206 is denied. Or, the presentation module 224 may access a communication promoting a new service associated with a service offered by the payment processing service 206 and may generate a graphical element to present via a graphical user interface to promote the new service. In some examples, the presentation module 224 may receive instructions for generating and/or presenting graphical element(s) and/or graphical user interface(s) from the payment processing service 206.

The merchant profile 228 may store data associated with a merchant (e.g., merchant 204A) including, but not limited to, data including information about the merchant 204A (e.g., name of the merchant, geographic location of the merchant, types of goods or services offered by the merchant, operating hours of the merchant, a merchant identifier, a merchant category classification, a URL associated with the merchant website, etc.), information about events associated with the merchant 204A (e.g., past and upcoming events, dates of events, locations of events, etc.), accounting information associated with the merchant 204A (e.g., bank(s) that the merchant banks with, etc.), contractual information associated with the merchant 204A (e.g., terms of a contract between the merchant and the payment processing service), transactional information associated with the merchant 204A (e.g., transactions conducted by the merchant, goods and/or service associated with the transactions, total spends of each of the transactions, parties to the transactions, dates, times, and/or locations associated with the transactions, etc.), etc. In some examples, at least a portion of the merchant profile 228 may be stored in the data store 212, as described below.

As described above, the payment processing service 206 may include one or more servers 210. The server(s) 210 may include processing unit(s) 230, computer-readable media 232, and a network interface 234. The processing unit(s) 230 of the server(s) 210 may execute one or more modules and/or processes to cause the server(s) 210 to perform a variety of functions, as set forth above and explained in further detail in the following disclosure. In some examples, the processing unit(s) 230 may include a CPU, a GPU, both CPU and GPU, or other processing units or components known in the art. Additionally, each of the processing unit(s) 230 may possess its own local memory, which also may store program modules, program data, and/or one or more operating systems. Depending on the exact configuration and type of the server(s) 210, the computer-readable media 232 may include volatile memory (such as RAM), non-volatile memory (such as ROM, flash memory, miniature hard drive, memory card, or the like), or some combination thereof. The server(s) 210 may include a network interface 234 for interfacing with the network(s) 208, as described below.

In at least one example, the computer-readable media 232 may include one or more modules for crawling websites and/or classifying merchants. The one or more modules may be implemented as more modules or as fewer modules, and functions described for the modules may be redistributed depending on the details of the implementation. As described above, the term “module” refers broadly to software stored on non-transitory storage medium (e.g., volatile or non-volatile memory for a computing device), hardware, or firmware (or any combination thereof) modules. Modules are typically functional such that they that may generate useful data or other output using specified input(s). A module may or may not be self-contained. An application program (also called an “application”) may include one or more modules, or a module may include one or more application programs. In some examples, a module may include an API to perform some or all of its functionality (e.g., operations). In additional and/or alternative examples, the module(s) may be implemented as computer-readable instructions, various data structures, and so forth via at least one processing unit (e.g., processing unit(s) 230) to configure the server(s) 210 to execute instructions and to perform operations described herein. The module(s) may include a training module 236, a crawler module 238, a scoring module 240, a classification module 242, and a communication module 246.

The training module 236 may be configured to train data model(s). In an example, the training module 236 may train a data model for determining a score associated with the complexity of a website (i.e., a complexity score). In an additional and/or alternative example, the training module 236 may train a data model for classifying a merchant. In at least one example, the training module 236 may utilize a machine learning mechanism to build, modify, or otherwise utilize a data model that is created from example inputs and makes predictions or decisions. In such an example, the data model may be trained using supervised learning algorithms (e.g., artificial neural networks, Bayesian statistics, support vector machines, decision trees, classifiers, k-nearest neighbor, etc.), unsupervised learning algorithms (e.g., artificial neural networks, association rule learning, hierarchical clustering, cluster analysis, etc.), semi-supervised learning algorithms, deep learning algorithms, etc.

In at least one example, the training module 236 may access training data. The training data may include data associated with previously crawled websites and complexity scores associated with such websites. That is, an example of a training data item may include data identifying content of a website (identified based on the structure of the website) and a complexity score associated with the website. The training module 236 may train a data model based on a plurality of training data items such that, given a new input of content associated with a web site, the data model may output a complexity score associated with the website. In at least one example, the training module 236 may provide the data model to the data store 212 and the data model may be stored in a database associated with model(s) 246.

In an additional and/or alternative example, the training data may include data associated with previously crawled websites and classifications of merchants associated with such websites. That is, an example of a training data item may include data identifying content of a website (identified based on the structure of the website) and a classification of a merchant associated with the web site. The training module 236 may train a data model based on a plurality of training data items such that, given a new input of content associated with a website, the data model may output a classification of the merchant associated with the website. In at least one example, the training module 236 may provide the data model to the data store 212 and the data model may be stored in a database associated with model(s) 246.

The training module 236 may receive updated training data for iteratively training and updating the data model(s).

The crawler module 238 may be configured to visit a website and to analyze the structure of the website. In at least one example, the crawler module 238 may be a headless browser (i.e., a web browser without a graphical user interface). As described above, in at least one example, the crawler module 238 may be associated with a set of policies, which may indicate which website(s) and/or data associated with the website(s) to download, when to revisit website(s), how to avoid overloading website(s), how to coordinate distributed web crawlers, etc. In at least one example, the crawler module 238 may access a URL and, based at least in part on an actuation of an access mechanism associated with the URL, may access (or attempt to access) a website associated with the URL. As described above, a website may be associated with a structure that describes content of the website. The structure may be described in a programming language for creating webpages, web applications, websites, etc. (e.g., Hypertext Markup Language (HTML), Javascript, Cascading Style Sheets (CSS), etc.). In at least one example, the crawler module 238 may access the structure of the website to determine content of the web site.

In at least one example, the crawler module 238 may attempt to access a website and may determine that the website is not accessible and/or is otherwise invalid. For instance, a domain may have lapsed or a website may not load upon accessing the website. In such examples, the crawler module 238 may determine an absence of a valid website.

In other examples, the crawler module 238 may access a valid website and access the structure of the website, as described above. Based at least in part on accessing the structure of the website, the crawler module 238 may determine one or more applications associated with the website, application providers associated with the one or more applications, metrics associated with functionality(s) of the website, contact(s) of the corresponding merchant that are identifiable via the website, contact data (e.g., telephone number(s), email address(es), physical address(es), etc.) associated with the corresponding merchant that is identifiable via the website, etc. Applications and application providers are described above. Metrics may correspond to predictions based on the content of the website. For instance, a metric may correspond to a predicted likelihood that a merchant has multiple merchant locations. Such a metric may be determined based at least in part on the number of street addresses listed on the website, the number of pin locations on a map associated with the website, etc. Or, a metric may correspond to a predicted likelihood that a website processes payments. Such a metric may be based on the presence or absence of application(s) associated with the website (e.g., a payment processing application, an e-commerce cart application, etc.). An additional and/or alternative metric may correspond to a predicted likelihood that a website accepts reservations. Such a metric may be based on the presence or absence of application(s) associated with the website (e.g., a reservation application, etc.).

In some examples, the crawler module 238 may download data associated with a website for subsequent access and analysis. In such examples, the crawler module 238 may store the data in the data store 212 in a database associated with website data 248. In such examples, the crawler module 238 may access the website data 248 at a time after the crawler module 238 visits the website and the crawler module 238 may analyze the website data 248 to determine content of the website as described above.

The scoring module 240 may be configured to determine a score associated with a website. The score may be representative of the complexity of the website (i.e., a complexity score). In at least one example, the scoring module 240 may determine a complexity score based on a set of rules. For instance, a set of rules may indicate how to score various content items of a website. In other examples, the scoring module 240 may determine a complexity score based on a previously trained data model, as described above. In such examples, the data model may leverage content associated with a website and may output a complexity score based on the content.

In at least one example, the complexity score may be based on whether a website is a valid web site. That is, in at least one example, a URL may not direct to a valid web site. In such an example, an absence of a valid website may affect the complexity score. In additional and/or alternative examples, the complexity score may be based on one or more applications determined to be associated with a web site, application providers associated with the one or more applications, metrics associated with functionality(s) of the web site, contact(s) of the corresponding merchant that are identifiable via the website, contact data (e.g., telephone number(s), email address(es), physical address(es), etc.) associated with the corresponding merchant that is identifiable via the website, etc. Combinations of applications may affect the complexity score. The presence or absence of certain application providers may affect the complexity score. The number of contact(s) of a merchant may affect the complexity score. The number of merchant locations of a merchant may affect the complexity score. The presence or absence of contact information and/or the type of contact information that is present may affect the complexity score.

As described above, a complexity score above a threshold complexity score, or within a particular range of complexity scores, may indicate that a website is a high-level (i.e., sophisticated) website. Alternatively, a complexity score below a threshold complexity score, or outside of the particular range of complexity scores, may indicate that a website is a low-level (i.e., unsophisticated) website. In at least one example, different ranges of complexity scores may correspond to different levels of complexity.

As a non-limiting example, a first web site associated with a first merchant may include a payment processing service associated with Application Provider A (a service used by sophisticated users), a content management service associated with Application Provider B (a service used by moderately sophisticated to sophisticated users), and contact data identifying multiple merchant locations. A second website associated with a second merchant may include a payment processing service associated with Application Provider C (a service used by unsophisticated users), a content management service associated with Application Provider D (a service used by unsophisticated users to moderately sophisticated users), and no indication of contact data associated with the second merchant. In such an example, the first website may be associated with a higher complexity score than the second website.

As another non-limiting example, a first web site associated with a first merchant may include a payment processing service associated with Application Provider A (a service used by sophisticated users), an e-commerce platform service associated with Application Provider B (a service used by moderately sophisticated to sophisticated users), a scheduling service associated with Application Provider C (a service used by unsophisticated users), and contact data identifying a single merchant location. A second website associated with a second merchant may include a payment processing service associated with Application Provider D (a service used by moderately sophisticated users), a loyalty program service associated with Application Provider E (a service used by moderately sophisticated users), and contact data identifying multiple merchant locations. In such an example, the first website may be associated with a lower complexity score than the second website.

The classification module 242 may be configured to classify a merchant. In at least one example, the classification module 242 may leverage a previously trained data model, described above, to determine a classification of a merchant. That is, in at least one example, the classification module 242 may leverage content associated with the web site and may output a classification based at least in part on the content associated with the website.

In at least one example, the data model may be a multi-class data model. That is, the classification module 242 may access content associated with a website and, based at least in part on applying the data model to the content associated with the website, may output a plurality of classes. In such an example, each class of the plurality of classes may be associated with a value, a percentage, or some other indicator indicating a likelihood that the merchant is associated with each class. In at least one example, each class in the plurality of classes may correspond to a service offered by the payment processing service 206 of which the merchant may benefit from using. In some examples, the classification module 242 may rank the plurality of classes based at least in part on the associated value, percentage, or other indicator and may determine that a highest-ranking class is the classification associated with the merchant. In such an example, the highest-ranking class may correspond to a service that may be most beneficial to the merchant. In other examples, the classification module 242 may output more than one classification based on a predetermined number of highest-ranking classes or a number of classes above a threshold value, threshold percentage, or threshold indicator.

As a non-limiting example, a website associated with a merchant may include a payment processing service associated with Application Provider A (a service used by sophisticated users), a content management service associated with Application Provider B (a service used by moderately sophisticated to sophisticated users), a reservation service associated with Application Provider C (a service used by unsophisticated users), and contact data identifying multiple merchant locations. In such an example, the classification module 242 may determine that the merchant may benefit from a reservation service offered by the payment processing service 206. That is, the classification module 242 may classify the merchant as a merchant that may benefit from a reservation service offered by the payment processing service 206. The classification module 242 may additionally and/or alternatively classify the merchant as a merchant that may benefit from a food ordering service or some other service available from the payment process service 206.

As another non-limiting example, a first web site associated with a first merchant may include a payment processing service associated with Application Provider A (a service used by unsophisticated users) and contact data identifying a single merchant location. In such an example, the classification module 242 may classify the merchant as a fraudulent merchant.

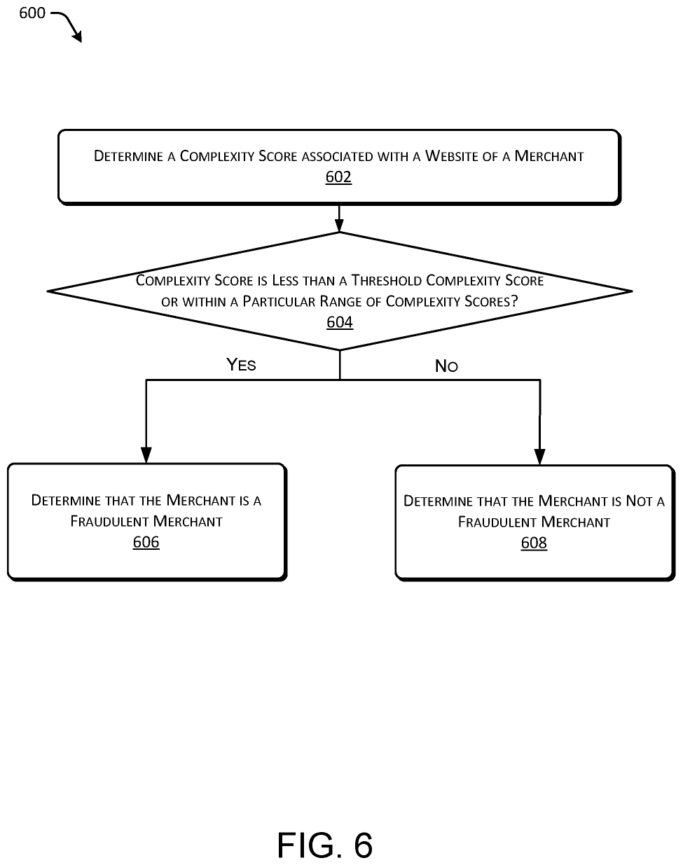

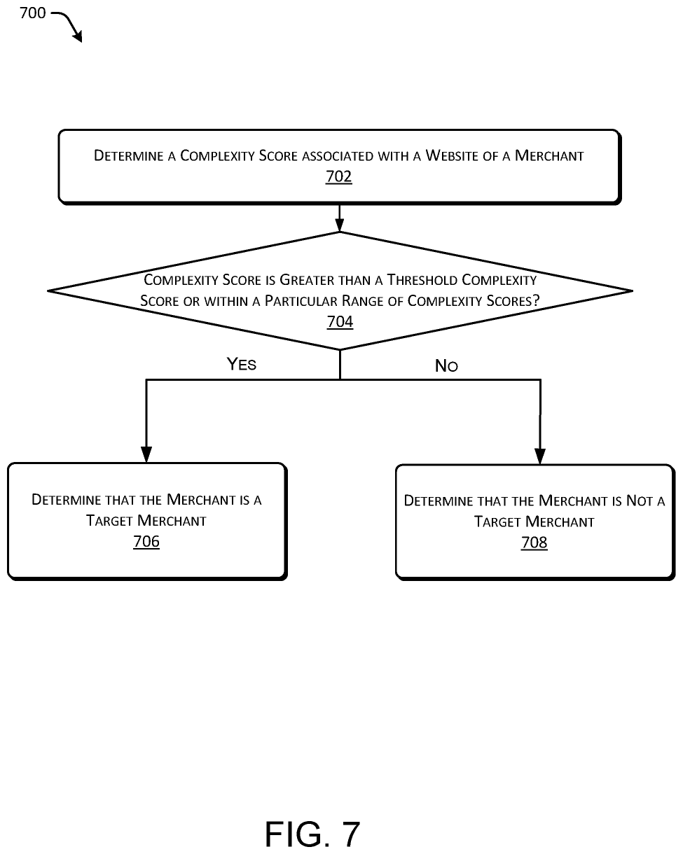

In addition to, or as an alternative of, using the data model to classify the merchant, in at least one example, the classification module 242 may leverage the complexity score to classify a merchant. For instance, the classification module 242 may receive a complexity score associated with a website and may determine a classification of a merchant based on the complexity score. In some examples, the classification module 242 may compare the complexity score with a threshold complexity score or a range of threshold complexity scores associated with a classification to classify a merchant, as described below with respect to FIGS. 6 and 7. In some examples, the classification module 242 may determine a classification of a merchant based on the complexity score associated with the website and the content associated with the website. In such examples, the complexity score may be utilized as an input to the data model with content determined from the structure of the website.

In at least one example, the classification module 242 may classify the merchant as a fraudulent merchant, a target merchant, a merchant that may benefit from a particular service offered by the payment processing service, etc.

The communication module 244 may exchange communication(s) with the devices 202. For instance, the communication module 244 may receive the merchant data (including the URL) from the interaction module 222. In some examples, the communication module 244 may receive the merchant data (including the URL) in association with a request to open a new account associated with the payment processing service 206, as described above. In at least one example, the communication module 244 may provide the URL to the crawler module 238. Additionally and/or alternatively, the communication module 244 may provide the merchant data and/or the URL to the data store 212 and may associate the merchant data and/or the URL with a merchant profile 250 in the merchant profile(s) 250.

Additionally and/or alternatively, the communication module 244 may send communication(s) to the devices 202. For instance, the communication module 244 may send a communication indicating that access to the payment processing service 206 is denied or terminated. Or, in other examples, the communication module 244 may send a communication promoting a new service associated with a service offered by the payment processing service 206. As described above, a communication may be an email, a text message, a SMS or MMS message, a push notification, content presented via a webpage, etc. that may be sent from the communication module 244 to a device 202A. In some examples—for instance, when the classification indicates that the merchant is a fraudulent merchant—the communication may be an indication denying or terminating access to the payment processing service 206. In other examples—for instance, when the classification indicates that the merchant may benefit from a particular service offered by the payment processing service 206—the communication may be an advertisement or some other promotional communication promoting the service and/or the payment processing service 206.

The server(s) 210 may further include a data store 212. The data store 212 may be configured to store data so that it may be accessible, manageable, and updatable. The data store 212 may be communicatively coupled to the server(s) 210 or integrated with the server(s) 210. In at least one example, the data store 212 may include model(s) 246, website data 248, and/or merchant profile(s) 250. In some examples, model(s) 246, website data 248, and/or merchant profile(s) 250 may be associated with individual databases, as illustrated in FIG. 2. In other examples, model(s) 246, website data 248, and/or merchant profile(s) 250 may be associated with a single database. Model(s) 246 may store one or more data models trained via the training module 236, as described above. Website data 248 may store data fetched by the crawler module 238, as described above. In at least one example, the website data 248 may be associated with temporary storage and the website data 248 may be removed after a lapse in a predetermined period of time, at a particular frequency, etc.

The merchant profile(s) 250 may store one or more merchant profiles. A merchant profile 250 may store data associated with a merchant (e.g., merchant 204A) including, but not limited to, data including information about the merchant 204A (e.g., name of the merchant, geographic location of the merchant, types of goods or services offered by the merchant, operating hours of the merchant, a merchant identifier, a merchant category classification, a URL associated with the merchant website, etc.), information about events associated with the merchant 204A (e.g., past and upcoming events, dates of events, locations of events, etc.), accounting information associated with the merchant 204A (e.g., bank(s) that the merchant banks with, etc.), contractual information associated with the merchant 204A (e.g., terms of a contract between the merchant and the payment processing service), transactional information associated with the merchant 204A (e.g., transactions conducted by the merchant, goods and/or service associated with the transactions, total spends of each of the transactions, parties to the transactions, dates, times, and/or locations associated with the transactions, etc.), etc.

Network(s) 208 may be any type of network known in the art, such as a local area network or a wide area network, such as the Internet, and may include a wireless network, such as a cellular network, a local wireless network, such as Wi-Fi and/or close-range wireless communications, such as Bluetooth®, BLE, NFC, RFID, a wired network, or any other such network, or any combination thereof. Accordingly, network(s) 208 may include both wired and/or wireless communication technologies, including Bluetooth®, BLE, Wi-Fi and cellular communication technologies, as well as wired or fiber optic technologies. Components used for such communications may depend at least in part upon the type of network, the environment selected, or both. Protocols for communicating over such networks are well known and will not be discussed herein in detail. Consequently, the devices 202 and/or the payment processing service 206 may communicatively couple to network(s) 208 in any manner, such as by a wired or wireless connection. Network(s) 208 may also facilitate communication between the devices 202 and the payment processing service 206. In turn, network interfaces (e.g., network interface 220 and network interface 234) may be any network interface hardware components that may allow the devices 202 and/or the server(s) 210 to communicate over the network(s) 208.

FIGS. 3-7 illustrate various processes for classifying a merchant based on content derived from web crawling a website of the merchant. The processes described herein are illustrated as collections of blocks in logical flow diagrams, which represent a sequence of operations, some or all of which may be implemented in hardware, software or a combination thereof In the context of software, the blocks may represent computer-executable instructions stored on one or more computer-readable media that, when executed by one or more processors, program the processors to perform the recited operations. Generally, computer-executable instructions include routines, programs, objects, components, data structures and the like that perform particular functions or implement particular data types. The order in which the blocks are described should not be construed as a limitation. Any number of the described blocks may be combined in any order and/or in parallel to implement the process, or alternative processes, and not all of the blocks need be executed. For discussion purposes, the processes are described with reference to the environments, architectures and systems described in the examples herein, although the processes may be implemented in a wide variety of other environments, architectures and systems.

FIG. 3 depicts a non-limiting flow diagram illustrating a method 300 for training a data model to determine a complexity score associated with a website in accordance with some examples of the present disclosure. FIG. 3 is described below in the system 200 described above with reference to FIG. 2, but is not limited to such a system.

Block 302 illustrates accessing training data associated with content of a plurality of websites and complexity scores associated with the plurality of websites. As described above, the training module 236 may access training data. The training data may include data associated with previously crawled websites and complexity scores associated with such websites. That is, an example of a training data item may include data identifying content of a website (identified based on the structure of the website) and a complexity score associated with the website. An additional example of a training data item may be data identifying an invalid website and a complexity score associated with the invalid web site.

Block 304 illustrates training a data model based at least in part on the training data, the data model determining a complexity score based on content associated with a website. The training module 236 may train a data model based on a plurality of training data items such that, given a new input of content associated with a website, the data model may output a complexity score associated with the website. In at least one example, the training module 236 may utilize a machine learning mechanism to train the data model. In such an example, the data model may be trained using supervised learning algorithms (e.g., artificial neural networks, Bayesian statistics, support vector machines, decision trees, classifiers, k-nearest neighbor, etc.), unsupervised learning algorithms (e.g., artificial neural networks, association rule learning, hierarchical clustering, cluster analysis, etc.), semi-supervised learning algorithms, deep learning algorithms, etc.

Block 306 illustrates iteratively updating the data model. In at least one example, the training module 236 may receive updated training data. For instance, the training module 236 may receive updated training data after a lapse of a predetermined period of time, at a particular frequency, etc. The updated training data may include additional and/or alternative data associated with previously crawled websites and complexity scores associated with such websites.

FIG. 4 depicts a non-limiting flow diagram illustrating a method 400 for training a data model to determine classification of a merchant in accordance with some examples of the present disclosure. FIG. 4 is described below in the system 200 described above with reference to FIG. 2, but is not limited to such a system.

Block 402 illustrates accessing training data associated with content of a plurality of websites associated with a plurality of merchants and classifications of the plurality of merchants. In at least one example, the training data may include data associated with previously crawled websites and classifications of merchants associated with such websites. That is, an example of a training data item may include data identifying content of a web site (identified based on the structure of the website) and a classification of a merchant associated with the website.

Block 404 illustrates training a data model based at least in part on the training data, the data model determining a classification of a merchant based on content data of a website associated with the merchant. The training module 236 may train a data model based on a plurality of training data items such that, given a new input of content associated with a web site, the data model may output one or more classifications of the merchant associated with the website. In at least one example, the training module 236 may utilize a machine learning mechanism to train the data model. In such an example, the data model may be trained using supervised learning algorithms (e.g., artificial neural networks, Bayesian statistics, support vector machines, decision trees, classifiers, k-nearest neighbor, etc.), unsupervised learning algorithms (e.g., artificial neural networks, association rule learning, hierarchical clustering, cluster analysis, etc.), semi-supervised learning algorithms, deep learning algorithms, etc.

Block 406 illustrates iteratively updating the data model. In at least one example, the training module 236 may receive updated training data. For instance, the training module 236 may receive updated training data after a lapse of a predetermined period of time, at a particular frequency, etc. The updated training data may include additional and/or alternative data associated with previously crawled websites and classifications of merchants associated with such websites.

FIG. 5 depicts a non-limiting flow diagram illustrating a method 500 for classifying a merchant based at least in part on content associated with a web site of the merchant in accordance with some examples of the present disclosure. FIG. 5 is described below in the system 200 described above with reference to FIG. 2, but is not limited to such a system.

Block 502 illustrates receiving an indication to crawl a website associated with a merchant, the web site being accessible by a URL. In at least one example, the crawler module 238 receive an indication to crawl a website associated with a merchant. In some examples, the indication may be associated with a request to open a new account with a payment processing service 206. In such examples, the request may be associated with a URL of the website. In other examples, the indication may be associated with a request to download a new Application Program Interface associated with the payment processing service 206. In such examples, the crawler module 238 may receive an indication to access a URL associated with a merchant making the request. In additional and/or alternative examples, the indication may be associated with a lapse in a period of time, a particular frequency, etc.

In some examples, the crawler module 238 may receive an input of a plurality of URLs, which may be associated with a plurality of URLs of merchants that have existing accounts with the payment processing service 206 or merchants that do not have existing accounts with the payment processing service 206. In such examples, the indication may be associated with such an input. That is, responsive to receiving an input of a plurality of URLs, the crawler module 238 may receive an indication to access a first URL of the plurality of URLs to crawl a website accessible by the URL.

Block 504 illustrates accessing the website via the URL. In at least one example, the crawler module 238 may access a URL and, based at least in part on an actuation of an access mechanism, may access a web site associated with the URL. In an alternative example as described above, the URL may direct to an invalid website.

Block 506 illustrates analyzing, via a web crawler, a structure of the website to derive content of the website. The crawler module 238 may be configured to access the website and to analyze the structure of the website. As described above, a website may be associated with a structure that describes content of the website. The structure may be described in a programming language for creating webpages, web applications, websites, etc. (e.g., Hypertext Markup Language (HTML), Javascript, Cascading Style Sheets (CSS), etc.). In at least one example, the crawler module 238 may access the structure of the website to determine content of the website. Based at least in part on accessing the structure of the website, the crawler module 238 may determine one or more applications associated with the website, application providers associated with the one or more applications, metrics associated with functionality(s) of the website, contact(s) of the corresponding merchant that are identifiable via the web site, contact data (e.g., telephone number(s), email address(es), physical address(es), etc.) associated with the corresponding merchant that is identifiable via the website, etc.

In some examples, the crawler module 238 may download data associated with a website for subsequent access and analysis. In such examples, the crawler module 238 may store the data in the data store 212 in a database associated with website data 248. In such examples, the crawler module 238 may access the website data 248 at a time after the crawler module 238 visits the website and the crawler module 238 may analyze the website data 248 to determine content of the website as described above.

In some examples, the scoring module 240 may be configured to determine a score associated with a website prior to method 500 proceeding to classifying the merchant. In such examples, method 500 may proceed to block 508, which illustrates determining a complexity score based on the content of the website. In other examples, the method 500 may proceed directly to block 510, which illustrates determining a classification of the merchant based on a data model.

As described above, block 508 illustrates determining a complexity score based on the content of the website. In at least one example, the scoring module 240 may determine a complexity score based on a set of rules. For instance, a set of rules may indicate how to score various content items of a website. In other examples, the scoring module 240 may determine a complexity score based on a previously trained data model, as described above. In such examples, the data model may leverage content associated with a website and may output a complexity score based on the content.

In at least one example, the complexity score may be based on whether a website is valid, one or more applications determined to be associated with the website, application providers associated with the one or more applications, metrics associated with functionality(s) of the website, contact(s) of the corresponding merchant that are identifiable via the website, contact data (e.g., telephone number(s), email address(es), physical address(es), etc.) associated with the corresponding merchant that is identifiable via the website, etc. Combinations of applications may affect the complexity score. The presence or absence of certain application providers may affect the complexity score. The number of contact(s) of a merchant may affect the complexity score. The number of merchant locations of a merchant may affect the complexity score. The presence or absence of contact information and/or the type of contact information that is present may affect the complexity score.

As described above, block 510 illustrates determining, based on a data model, a classification of the merchant. In examples where the scoring module 240 determines a score associated with the website, the classification module 242 may leverage the complexity score to classify a merchant. For instance, the classification module 242 may receive a complexity score associated with a website and may determine a classification of a merchant based on the complexity score. In some examples, the classification module 242 may compare the complexity score with a threshold complexity score or a range of threshold complexity scores associated with a classification to classify the merchant, as described below with respect to FIGS. 6 and 7.

In additional and/or alternative examples, the classification module 242 may classify a merchant based at least in part on a previously trained data model. That is, in at least one example, the classification module 242 may leverage content associated with the website, and in some examples a complexity score associated with the website, and may output a classification. In at least one example, the data model may be a multi-class data model. That is, the classification module 242 may access content associated with a website, and in some examples a complexity score associated with the website, and may output a plurality of classes, as described above.

As described above, the classification module 242 may classify the merchant as a fraudulent merchant, a target merchant, a merchant that may benefit from a particular service offered by the payment processing service, etc.

Block 512 illustrates sending, based at last in part on the classification, a communication to a device operated by the merchant. In at least one example, the communication module 244 may send communication(s) to the devices 202. As described above, a communication may be an email, a text message, a SMS or MMS message, a push notification, etc. that may be sent from the communication module 244 to a device 202A. The content of the communication(s) may be based on the classification of the merchant. In some examples—for instance, when the classification indicates that the merchant is a fraudulent merchant—the communication may be an indication denying or terminating access to the payment processing service 206. In other examples—for instance, when the classification indicates that the merchant is a target merchant and/or a merchant that may benefit from a particular service offered by the payment processing service 206—the communication may be an advertisement or some other promotional communication promoting the service and/or the payment processing service 206.

In some examples, method 500 may be repeated for each URL in a plurality of URLs. That is, in some examples, the crawler module 238 may receive a plurality of URLs. In such example, the crawler module 238 may access each URL in the plurality of URLs to initiate method 500. In such examples, a merchant associated with each URL may be classified by the classification module 242. In some examples, results of processing the plurality of URLs may be aggregated. That is, after processing each of the URLs in the plurality of URLs, data identifying the corresponding classified merchants may be aggregated. The aggregated data may be sortable, searchable, etc. In at least one example, the classification module 242 may group classified merchants together based on classification, complexity score, etc. For instance, in at least one example, the classification module 242 may determine that two or more merchants are associated with websites having complexity scores in a particular range of complexity scores. In such an example, the classification module 242 may group the two or more merchants together and the group may be associated with a particular classification. As a result, the communication module 244 may send same communication(s) to each of the merchants in the group.

FIG. 6 depicts a non-limiting flow diagram illustrating a method 600 for classifying a merchant as a fraudulent merchant based at least in part on a complexity score in accordance with some examples of the present disclosure. FIG. 6 is described below in the system 200 described above with reference to FIG. 2, but is not limited to such a system.

Block 602 illustrates determining a complexity score associated with a website of a merchant. As described above with reference to block 508 in FIG. 5, the scoring module 240 may determine a complexity score associated with a website of a merchant.

Block 604 illustrates determining whether the complexity score is less than a threshold complexity score or within a particular range of complexity scores. In at least one example, the classification module 242 may receive a complexity score associated with a website and the classification module 242 may compare the complexity score with a threshold complexity score, or a particular range of complexity scores, that indicates that a merchant is not a fraudulent merchant.

Based at least in part on determining that the complexity score is less than the threshold complexity score, or within the particular range of complexity scores, the classification module 242 may determine that the merchant is a fraudulent merchant, as illustrated in block 606. As described above, based at least in part on determining that a merchant is a fraudulent merchant, the communication module 244 may send a communication to a device operated by the merchant indicating that access to the payment processing service 206 is denied and/or terminated. In some examples, the classification module 242 may flag the merchant for further review. Based at least in part on determining that the complexity score is greater than the threshold complexity score, or outside of the particular range of complexity scores, the classification module 242 may determine that the merchant is not a fraudulent merchant, as illustrated in block 608.

FIG. 7 depicts a non-limiting flow diagram illustrating a method 700 for classifying a merchant as a target merchant based at least in part on a complexity score in accordance with some examples of the present disclosure. FIG. 7 is described below in the system 200 described above with reference to FIG. 2, but is not limited to such a system.

Block 702 illustrates determining a complexity score associated with a website of a merchant. As described above with reference to block 508 of FIG. 5, the scoring module 240 may determine a complexity score associated with a website of a merchant.

Block 704 illustrates determining whether the complexity score is less than a threshold complexity score or within a particular range of complexity scores. In at least one example, the classification module 242 may receive a complexity score associated with a website and the classification module 242 may compare the complexity score with a threshold complexity score, or a particular range of complexity scores, that indicates that a merchant is a target merchant.

Based at least in part on determining that the complexity score is greater than the threshold complexity score, or within the particular range of complexity scores, the classification module 242 may determine that the merchant is a target merchant, as illustrated in block 706. As described above, based at least in part on determining that a merchant is a target merchant, the communication module 244 may send a communication to a device operated by the merchant that includes an advertisement or some other promotional communication promoting one or more services and/or the payment processing service 206. Based at least in part on determining that the complexity score is less than the threshold complexity score, or outside of the particular range of complexity scores, the classification module 242 may determine that the merchant is not a target merchant, as illustrated in block 708.

The foregoing is merely illustrative of the principles of this disclosure and various modifications may be made by those skilled in the art without departing from the scope of this disclosure. The above described examples are presented for purposes of illustration and not of limitation. The present disclosure also may take many forms other than those explicitly described herein. Accordingly, it is emphasized that this disclosure is not limited to the explicitly disclosed methods, systems, and apparatuses, but is intended to include variations to and modifications thereof, which are within the spirit of the following claims.

As a further example, variations of apparatus or process parameters (e.g., dimensions, configurations, components, process step order, etc.) may be made to further optimize the provided structures, devices and methods, as shown and described herein. In any event, the structures and devices, as well as the associated methods, described herein have many applications. Therefore, the disclosed subject matter should not be limited to any single example described herein, but rather should be construed in breadth and scope in accordance with the appended claims.

1-4. (canceled)

5. A computer-implemented method comprising:
accessing training data including a plurality of data items, wherein an individual data item of the plurality of data items comprises a first score associated with a previously crawled website and data identifying a structure of the website, and wherein the first score is representative of a sophistication level of at least one of the website or a user associated with the website;
training a data model based at least in part on the training data;
accessing, via a URL associated with a merchant, a merchant website corresponding to the URL;
analyzing the merchant website via a web crawler to identify a structure of the merchant web site;
determining, based at least in part on applying the data model to the structure of the merchant website, a second score, wherein the second score is representative of a sophistication level of at least one of the merchant or the merchant website;
determining whether the merchant is a fraudulent merchant based at least in part on the second score; and
based at least in part on determining whether the merchant is a fraudulent merchant, sending, to a device operable by the merchant and based at least in part on determining that the merchant is a fraudulent merchant, a communication to indicate that the merchant is denied access to one or more services availed via a payment processing service.

6-8. (canceled)

9. The computer-implemented method as claim 5 recites, wherein the structure indicates that the merchant website comprises one or more applications.

10. The computer-implemented method as claim 9 recites, wherein the structure indicates that the merchant website comprises an application provider associated with an application of the one or more applications.

11. The computer-implemented method as claim 9 recites, further comprising:
determining a likelihood that the merchant website performs a function associated with an application of the one or more applications,
wherein determining whether the merchant is a fraudulent merchant is further based at least in part on the likelihood that the merchant web site performs the function associated with the application.

12. The computer-implemented method as claim 5 recites, wherein the structure indicates that the merchant website comprises a number of contacts of the merchant.

13. The computer-implemented method as claim 5 recites, wherein the structure indicates that the merchant website comprises a number of merchant locations associated with the merchant.

14-20. (canceled)

21. A system comprising:
one or more processors; and
computer-readable media storing instructions, that when executed by the one or more processors, cause the one or more processors to perform operations comprising:
accessing training data including a plurality of data items, wherein an individual data item of the plurality of data items comprises a first score associated with a previously crawled website and data identifying a structure of the website, and wherein the first score is representative of a sophistication level of at least one of the website or a user associated with the website;
training a data model based at least in part on the training data;
accessing, via a URL associated with a merchant, a website corresponding to the URL;
analyzing the merchant website via a web crawler to identify a structure of the merchant website;
determining, based at least in part on applying the data model to the structure of the merchant website, a second score representative of the sophistication level of at least one of the merchant or the merchant website;
determining whether the merchant is a fraudulent merchant based at least in part on the second score; and
based at least in part on determining whether the merchant is a fraudulent merchant, sending, to a device operable by the merchant, a communication to indicate that (i) the merchant has been granted access to a new service or (ii) access to at least one service has been terminated or denied.

22. The system as claim 21 recites, wherein the determining whether the merchant is a fraudulent merchant based at least in part on the second score comprises:
determining that the second score is below a threshold score; and
determining that the merchant is a fraudulent merchant based at least in part on the second score being below the threshold score.

23. The system as claim 21 recites, wherein the determining whether the merchant is a fraudulent merchant based at least in part on the second score comprises:
determining that the second score is above a threshold score; and
determining that the merchant is not a fraudulent merchant based at least in part on the second score being above the threshold score.

24-28. (canceled)

29. One or more computer-readable media storing instructions, that when executed by one or more processors, cause the one or more processors to perform operations comprising:
accessing training data including a plurality of data items, wherein an individual data item of the plurality of data items comprises a first score associated with a previously crawled website and data identifying a structure of the website, and wherein the first score is representative of a sophistication level of at least one of the website or a user associated with the website;
training a data model based at least in part on the training data;
accessing, via a URL associated with a merchant, a merchant website corresponding to the URL;
analyzing the merchant website via a web crawler to identify a structure of the merchant web site;
determining, based at least in part on applying the data model to the structure of the merchant web site, a second score representative of the sophistication level of at least one of the merchant or the merchant website;
determining whether the merchant is a fraudulent merchant based at least in part on the second score; and
based at least in part on determining whether the merchant is a fraudulent merchant, sending, to a device operable by the merchant, a communication to indicate that (i) the merchant has been granted access to a new service or (ii) access to at least one service has been terminated or denied.

30. The one or more computer-readable media as claim 29 recites, wherein the determining whether the merchant is a fraudulent merchant based at least in part on the second score comprises:
determining that the second score is below a threshold score; and
determining that the merchant is a fraudulent merchant based at least in part on the second score being below the threshold score.

31.-33. (canceled)

34. The computer-implemented method as claim 33 recites, wherein the data model is trained using a machine-learning mechanism.

35. (canceled)

36. The computer-implemented method as claim 5 recites, wherein determining whether the merchant is a fraudulent merchant based at least in part on the second score comprises:
determining that the second score is below a threshold score; and
determining that the merchant is a fraudulent merchant based at least in part on the second score being below the threshold score.

37. The system as claim 21 recites, wherein the structure comprises one or more of:
one or more applications associated with the merchant website;
an application provider associated with an application of the one or more applications;
a likelihood that the merchant website performs a function associated with an application of the one or more applications;
a number of contacts of the merchant; or
a number of merchant locations associated with the merchant.

38. The system as claim 21 recites, wherein determining whether the merchant is a fraudulent merchant is further based at least in part on analyzing, using a multi-class classifier, data associated with the structure of the merchant website to classify the merchant as (i) a fraudulent merchant, (ii) a target merchant for onboarding to a payment processing service, or (iii) an upsell merchant for granting access to a particular service of the payment processing service.

39. The system as claim 38 recites, the operations further comprising determining that the merchant is a fraudulent merchant, wherein the communication indicates that access to at least one service has been terminated or denied.

40. The system as claim 38 recites, the operations further comprising determining that the merchant is a target merchant or an upsell merchant, wherein the communication indicates that the merchant has been granted access to a new service.

41. The computer-implemented method as claim 5 recites, wherein the data model is trained using a machine-learning mechanism.

42. The computer-implemented method as claim 9 recites, wherein the structure indicates that the merchant website comprises metrics associated with functionalities of the merchant website.

43. The computer-implemented method as claim 9 recites, wherein the structure indicates contact information for the merchant, wherein the contact information comprises one or more of a telephone number, an email address, or a physical address.
